(19) United States
(12) Patent Application Publication
(10) Pub. No.: US 2014/0213335 A1
(43) Pub. Date: Jul. 31, 2014

(54) Pinochle Proposition

(71) Applicant: Gene Squitieri, Las Vegas, NV (US)

(72) Inventor: Gene Squitieri, Las Vegas, NV (US)

(21) Appl. No.: 14/231,328

(22) Filed: Mar. 31, 2014

Related U.S. Application Data
(63) Continuation-in-part of application No. 13/507,622, filed on Jul. 16, 2012.

(51) Int. Cl. A63F 13/00

(52) U.S. Cl. CPC A63F 13/00
USPC 463/12

(57) ABSTRACT

A method is provided for playing a card game using a deck of cards with rules to define a value of the cards in the deck, in accordance with an example. The method may include distributing a plurality of cards to a player and a dealer. A main wager may be received from the player for the plurality of cards distributed to the player and a side wager may be received from the player for a first two of the plurality of cards distributed to the player. When the first two of the plurality of cards distributed to the player match a defined combination of cards, the player may be rewarded for the side wager.

### CROSS-REFERENCE TO RELATED APPLICATION

This application is a continuation-in-part of application Ser. No. 13/507,622, filed Jul. 6, 2012.

### BACKGROUND

### I. The Blackjack Game:

Blackjack, also known as Twenty-one (“21”), is a casino banking game widely played across the world. Blackjack is a comparison card game played between a Player and Dealer (also referred to as the “House”) and is played with one or more deck(s) of 52 cards. The Player is dealt an initial two card hand with the option of drawing additional cards to bring the total value to 21 or less without exceeding 21. The Dealer will lose by having a lesser hand than the Player or by exceeding 21 (also referred to as a “bust”).

### II. Basic Rules of Blackjack

The Player's object is to win money by creating card totals which will turn out to have a higher total value than the total value of the cards in the Dealer's hand, but without exceeding 21. Before the cards are dealt, Players typically place their bets in a designated area in front of each player's respective position at the table.

The Dealer may face up to seven Players at a time, for example, and may deal the cards in a clockwise rotation starting from the Dealer's leftmost position and going around twice until each Player has two cards (the Dealer included). The Players' cards are either face up or face down depending on House rules. The Dealer will have one card face up and one card face down (hole card).

The value of the cards in the deck are as follows:

Ace=1 or 11 (according to how the Player uses the card in their best interest),

King, Queen, Jack=10, and

10, 9, 8, 7, 6, 5, 4, 3, 2 are valued at their face value.

On their turn, Players must choose whether to “hit” (take a card), “stand” (end their turn), “double down” (double wager/typically on a total on 10 or 11 on the first two cards/and take a single card and end turn), “split” (if the two cards have the same value, separate them to make two hands), or “surrender” (if offered-give up half your bet and retire from that round) based on the value of the Players' first two cards.

If the Dealer's face up card is an Ace, then Players may have the option to take “Insurance” before the Dealer checks his/her face down (hole card). This bet is handled independently of the main bet. This bet gives the Player an opportunity to protect their main bet. If the Dealer's face down card (hole card) is a King, Queen, Jack or 10 the Dealer has Blackjack and the main bet is lost. The Insurance bet typically pays 2:1.

If at any time the Player hits (takes a card) and the value of the cards exceeds 21 they must forfeit their cards to the Dealer at which time the Player's main bet is removed and the Dealer moves onto the next Player.

The Dealer will resolve each Player's hands first before resolving theirs. The Dealer never doubles down, splits or surrenders.

Typically, Dealers draw on total card values of 16 or less, hit on all soft 17's and stand on all hard 17's (again depending on House rules). If the Dealer does not bust, each remaining

Player hand that is higher than the Dealer's, wins and the Player's hands that are lower lose. If the Dealer's and Player's hand total matches then the game is a “push” and the main bet is neither won nor lost.

If a Player's first two cards are a Blackjack (i.e., Ace with a King, Queen, Jack or 10) the Player wins the bet, typically at 3:2 (depending on House rules). However, if the Dealer also has a Blackjack then the hand is a “push”. FIG. 1 is an example photograph of a 7 card blackjack dealer hand.

### BRIEF DESCRIPTION OF THE DRAWINGS

FIG. 1 is an example photograph of a 7 card blackjack hand.

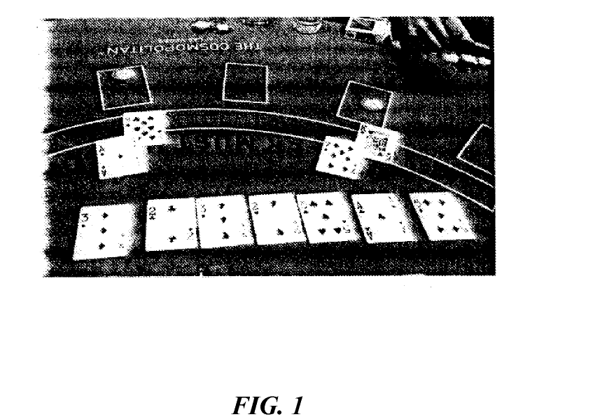

FIG. 2 is an example Blackjack table layout for Pinochle Proposition.

FIG. 3 is a block diagram of a system for a Pinochle Proposition game in accordance with an example of the present technology.

FIG. 4 is a flow diagram of a method for playing a card game in accordance with an example of the present technology.

FIG. 5 is a flow diagram of a method for playing a card game using representations of cards in accordance with an example of the present technology.

FIG. 6 is a flow diagram of a method a method for playing a card game using cards in accordance with an example of the present technology.

FIG. 7 is a block diagram of a system for a Pinochle Proposition game in accordance with an example of the present technology.

### DETAILED DESCRIPTION

### III. Pinochle Proposition

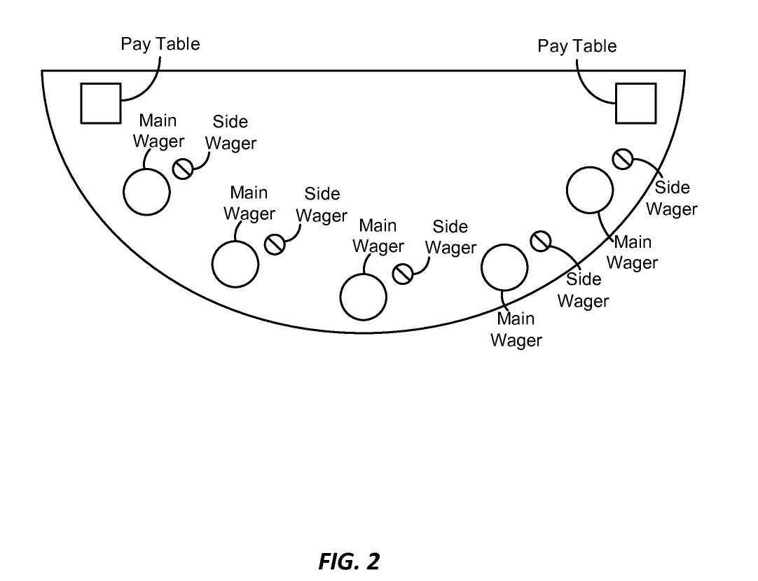

With reference to FIG. 2, illustrating an example Blackjack table layout for Pinochle Proposition, Pinochle Proposition is a simple, yet fun variation of the basic Blackjack game (for both video terminal and table game) . . . with one proposition/side bet offered. The side bet involves the Player's first two cards only.

In the popular trick taking, combination forming and point scoring card game known as Pinochle, Player's are dealt cards and proceed to make melds (card combo's) for points.

The game may use some of the popular melds/card combinations from the game Pinochle for a Player's side bet in in a Blackjack game, herein referred to as Pinochle Proposition. If a Player is dealt one of the card combinations listed below (first two cards only and/or independent of any cards dealt after the first two cards dealt to the Player) then the Player may win the Pinochle Proposition side bet:

Pinochle=Jack of Diamonds & Queen of Spades

Trump Marriage=King & Queen/Suited/*Trump

Royal Marriage=King & Queen/Suited/Non Trump

Common Marriage=King & Queen/Non Suited

Dix in Trump=“9” Card in *Trump [either of the Player's first two cards qualifies]
Trump is determined by Dealer's face up card suit—that suit is “Trump”.

### [Suits are Diamonds, Hearts, Clubs, Spades]

These card combinations are presented as examples and may not be limiting to the exclusion of other potential card combinations.

### IV. Rules for Pinochle Proposition

The basic rules of Blackjack still apply with one or more of these additional ten rules for the Pinochle Proposition bets :

1. The Pinochle Proposition bet is preferably made at the same time the Player's main bet is made. The Player will place the main bet and the Pinochle Proposition bet.

2. A Player may be restricted from placing a bet on the Pinochle Proposition without making a main bet.

3. Once the cards are dealt the Player may be restricted from taking back, adding to or otherwise changing the Pinochle Proposition bet (i.e., the side bet), if made.

4. Each Pinochle Proposition bet that is made may play one time—on the specific hand that it is being played.

5. If the Dealer is dealt a Blackjack then the Player's main bet may be lost but if the Pinochle Proposition bet is made and is a winner the Player may yet be paid.

6. There may be a specified betting area on the Blackjack table for the Pinochle Proposition bets.

7. If the House rules are that both Player's cards are dealt face down it is the responsibility of the Player to show the winning Pinochle Proposition hand to be paid. Preferably, the Player is to show the winning Pinochle Proposition hand immediately. In electronic implementations of the game, the player may press a button or otherwise make a selection indicating a desire to receive a reward for the winning Pinochle Proposition hand.

8. In the case of the Dix in Trump (one of the Player's first two cards is a “9” in Trump) the Player may show that card/hand immediately to be paid but may still play the remainder of the Player's hand, i.e. request additional cards (hit) to improve their hand. The same may be true for other defined card combinations or may be restricted to Dix in Trump hands.

9. The Trump suit for each round dealt may be determined by the Dealer's face up card suit—e.g. if the Dealer's face up card is a 10 of Diamonds then the Diamond suit is Trump for that hand. Alternatively, the Trump suit may be a different card than a Dealer's face up card.

10. In the case where a Player splits cards, the split hands may not qualify for the Pinochle Proposition side wager.

### V. Pay Table For Winning Bets

If a Player is dealt one of the card combinations listed below (first two cards) then they may win the Pinochle Proposition side bet immediately with these example payouts:

250:1 Pinochle=Jack of Diamonds & Queen of Spades

200:1 Trump Marriage=King & Queen/Suited/Trump

100:1 Royal Marriage=King & Queen/Suited/Non Trump

30:1 Common Marriage=King & Queen/Non Suited

5:1 Dix in Trump=“9” Card in Trump

The numbers in these payout examples may represent how the Player is to be paid or rewarded. The numbers, in the format of X:Y represent a multiplier (X) for calculating the reward value per (Y) units of currency. For example, if the Player wagered $10 and held a Dix in Trump hand, the Player would be rewarded 5×$10=$50.

Side bets may be made without regard to the suit. In other words, the Player may make the side bet or side wager without specifying any particular suit, rank, card combination, etc. The card combinations may be pre-determined and the Trump suit may be based on one of the card's dealt to the dealer. The suit of the Player's cards may affect the payout, but the Player is not betting for a particular suit. Rather, the wager is that the first two cards dealt to the Player will result in one of the defined combinations. When a suit of the dealer's first card matches the card combination held by the Player, or in other words, the card combination held by the Player is in the trump suit, then the reward or payout may be greater than when the card combination held by the Player is not in the trump suit, at least where the card combination is such that the Player is to be rewarded with some reward regardless of suit, such as the Common Marriage combination identified above.

The cards may each have a suit (i.e., spades ( [symbol] ), hearts (♡), diamonds (♦), clubs ( [symbol] )) and a number, value, or rank (i.e., 2, 3, 4, 5, 6, 7, 8, 9, 10, Jack (J), Queen (Q), King (K), Ace (A)). As used herein, the terms “number”, “value” and “rank” as used to describe a number or other marking or designation on the card are to be considered synonymous. The defined card combinations for resulting in a reward to the player include at least the rank and optionally further include the suit.

For the 9 card in trump/dix example, although the rank of a single card is specified and the rank and suit of a second of the first two cards distributed to the player is unspecified, the defined combinations of cards resulting in a reward to the player may include any two-card combination include at least one ‘9’ card. Thus, when determining whether a rank of the first two of the plurality of cards distributed to the player matches a defined combination of cards for winning the side wager, when the rank of one of the cards is a 9 and the rank of the other of the cards is any rank, the combination of a 9 with any rank matches the defined combination for the 9 card in trump/dix reward.

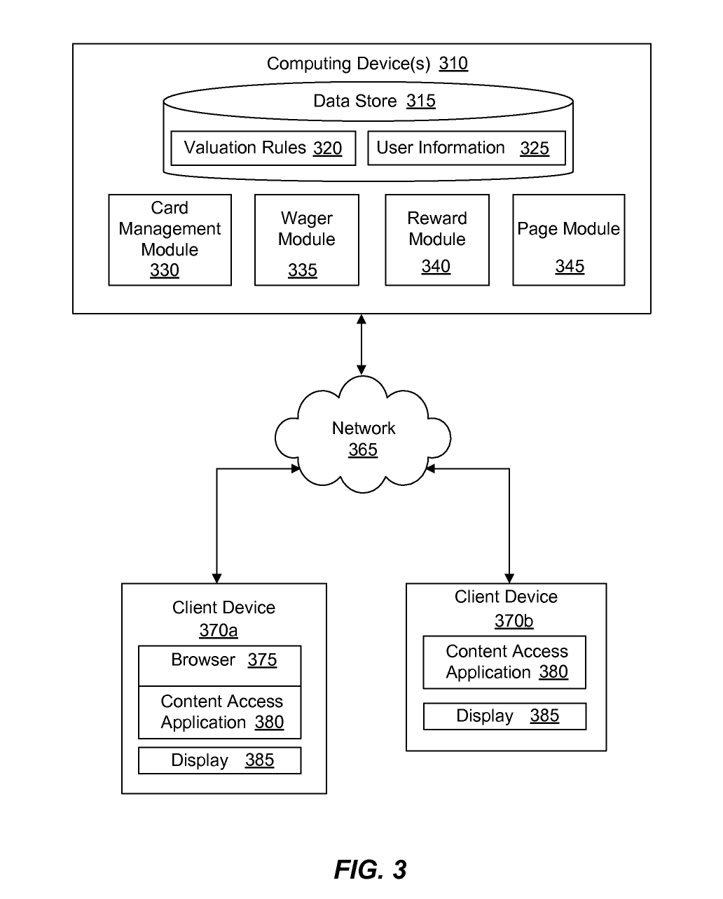

Referring now to FIG. 3, a block diagram of a system is illustrated that may be used for a game of Pinochle Proposition in accordance with an example of the present technology. The computing device 310 may be an implementation of a node in a virtualized computing system or may include a physical server, personal computer, mobile device or the like. The computing device 310 may be a server in a virtualized or distributed computing system and the client devices 370a-370b may be used by users to interact with the computing system using, for example, a client application 380 or browser application 375 and a display 385 on the client device 370a, 370b. The computing device 310 may include a data store 315 and a number of modules 330, 335, 340, 345 for storing and processing data.

A valuation rules data store 320 may include, for example, rules relating to the valuation of the cards. Some of the cards used for the game may have a variable valuation, such as an ace card, for example, while other cards may have a fixed valuation, such as fixed at the face value of the card (e.g., 2, 3, 4, 5, etc.). The valuation rules data store may include rules for interpreting which valuation to use for a card in a given context, at least where the valuation is variable, and may be accessed for summing the total value of cards dealt to a player or dealer.

A user information data store 325 may optionally be present and may include, for example, data to users, or rather to the players playing the game. For example, the user information data store 325 may include an account balance or credit, payment information, user identity information, game history, wager history, and so forth.

While FIG. 3 illustrates data store 315 as including the valuation rules data store 320 and the user information data store 325, these respective data stores may be independent of one another and may be stored separately from one another as opposed to being different portions of a same data store (i.e., data store 315).

The computing device 310 may interface with the network 365. In this way, the computing device 310 may be able to communicate with the client device 370a, 370b. This communication may be further operable with various modules within the computing device 310. For example, the page module 345 may communicate with the client device 370a, 370b over the network 365 directly or via one or more intermediate modules.

The system may include the page module 345 for displaying network pages, including user interfaces, user data and any other suitable object or data for facilitating or enhancing user interaction with the system. The page module 345 may be used for providing data, graphical user interfaces and so forth for display on the client device 370a, 370b.

The system may include other modules, such as a card management module 330, a wager module 335, and a reward module 340, for example. The card management module 330 may be used to distribute cards to the player(s) and the dealer, to reveal cards, to track a number of cards dealt, to sum cards using the rules in the valuation rules data store 320, to determine whether a player or dealer has busted, and so forth. The wager module 335 may permit a user to make main and side wagers. For example, the wager module 335 may access an account balance or a credit card number from the user information data store 325 to process a wager for a particular game. When a game is over, the reward module 340 may use data from the card management module to identify whether a wager is won and how much to pay out when the wager is won, as well as to make the payment or deposit to the player.

The computing device 310 may comprise, for example, a server computer, a virtual server image, or any other system providing computing capability. Alternatively, a plurality of computing devices 310 may be employed that are arranged, for example, in one or more server banks or computer banks or other arrangements to form a distributed computing system.

Client devices 370a-370b may access data, reports and so forth via the computing device 310 over the network 365. Example client devices 370a-370b may include, but are not limited to, a desktop computer, a laptop, a tablet, a mobile device, a television, a cell phone, a smart phone, a hand held messaging device, a set-top box, a gaming console, a personal data assistant, an electronic book reader, heads up display (HUD) glasses, a car navigation system, or any device with a display 385.

Various processes and/or other functionality, as discussed herein, may be executed according to various examples. The computing device 310, may for example, provide some central server processing services while the client device 370a, 370b may provide local processing services and interface processing services to interface with the services of the computing device 310. Therefore, it is envisioned that processing services, as discussed herein, may be centrally hosted functionality or a service application that may receive requests and provide output to other services or user devices.

For example, the services may be considered on-demand computing that is hosted in a server, cloud, grid, or cluster computing system. An application program interface (API) may be provided for each service to enable a second service to send requests to and receive output from the first service. Such APIs may also allow third parties to interface with the service and make requests and receive output from the service. A processor may provide processing instructions by communicating with a memory on the computing device 310. In other words, the memory device may include instructions operable to be executed by the processor to perform a set of actions. The processor and/or the memory may directly or indirectly communicate with the data store 315.

Various data may be stored in the data store 315 that is accessible to the computing device 310. The term “data store” may refer to any virtualized device or combination of physical and virtual devices capable of storing, accessing, organizing and/or retrieving data, which may include any combination and number of data servers, relational databases, object oriented databases, data storage devices, data warehouses, flat files and data storage configuration in any centralized, distributed, or clustered environment. The storage system components of the data store 315 may include storage systems such as a SAN (Storage Area Network), a cluster storage network, volatile or non-volatile RAM, optical media, or hard-drive type media. The data store 315 may be representative of a plurality of data stores 315.

The client devices 370a, 370b shown in FIG. 3 are representative of a plurality of client devices that may be coupled to the network. The client devices may communicate with the computing device 310 over any appropriate network, including an intranet, the Internet, a cellular network, a local area network (LAN), a wide area network (WAN), a wireless data network or a similar network or combination of networks.

Each client device 370a, 370b may include a respective display 385. The display 385 may comprise, for example, one or more devices such as cathode ray tubes (CRTs), liquid crystal display (LCD) screens, gas plasma based flat panel displays, LCD projectors, or other types of display devices, etc.

Each client device 370a, 370b may be configured to execute various applications such as a browser 375, client application 380 and/or other applications. The browser 375 may be executed in a client device 370a, 370b, for example, to access and render pages, such as web pages or other network data served up by the computing device 310 and/or other servers. The client application 380 may be executed to obtain and render for display data from the computing device 310, or other services and/or local storage media. A client device may be a hardware device which is used by the user to access a virtual computing instance.

In some embodiments, the client application 380 may correspond to code that is executed in the browser 375 or plug-ins to the browser 375. In other embodiments, the client application 380 may correspond to a standalone application, such as a mobile application. The client device 370a, 370b may be configured to execute applications beyond those mentioned above, such as, for example, mobile applications, email applications, instant message applications and/or other applications. Users at client devices 370a, 370b may access data, such as the processed result of operating information reports, through display devices or through client applications 380 executed in the client devices 370a, 370b.

Certain processing modules may be discussed in connection with this technology. In one example configuration, a module may be considered a service with one or more processes executing on a server or other computer hardware. Such services may be centrally hosted functionality or a service application that may receive requests and provide output to other services or customer devices. For example, modules providing services may be considered on-demand computing that is hosted in a server, cloud, grid or cluster computing system. An application program interface (API) may be provided for each module to enable a second module to send requests to and receive output from the first module. Such APIs may also allow third parties to interface with the module and make requests and receive output from the modules. Third parties may either access the modules using authentication credentials that provide on-going access to the module or the third party access may be based on a per transaction access where the third party pays for specific transactions that are provided and consumed.

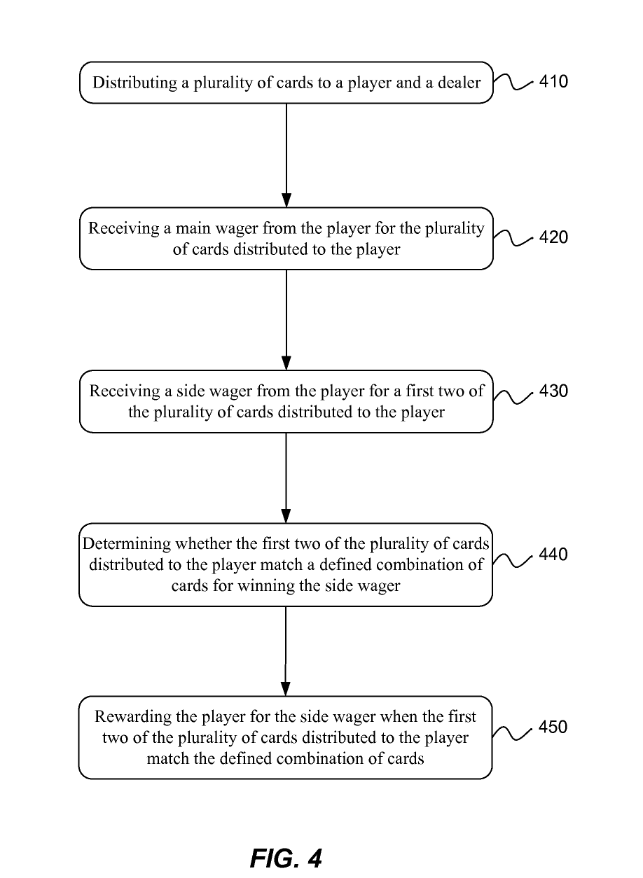

Referring now to FIG. 4, a flow diagram of a computer-implemented method for playing a card game using a deck of cards, with rules to define a value of the cards in the deck, is illustrated in accordance with an example of the present technology. The method may be performed under the control of one or more computer systems configured with executable instructions, and may include, for example, distributing 410 cards to a player and a dealer. The method may further include receiving 420 a main wager from the player for the plurality of cards distributed to the player. The player may select a first value for the main wager using an interface with the computing system. For example, the first value may be selected and submitted virtually using an electronic account of the player, by swiping a credit card, inserting physical cash into the system, or any of a variety of other mechanisms for selecting and/or submitting the wager.

The method may further include receiving 430 a side wager from the player for a first two of the plurality of cards distributed to the player. The side wager may be selected or submitted by the player similarly as with the main wager. The side wager may be a lower, higher, or similar amount as the main wager. The method may further include determining 440 whether a rank of the first two of the plurality of cards distributed to the player matches a defined combination of cards for winning the side wager. For example, the cards distributed to the player may be analyzed to determine whether the rank(s) satisfy any of the defined card combinations. If yes, then the method may further include determining whether the suit of the first two of the plurality of cards distributed to the player matches the suit for the defined card combination(s) matched by the rank(s). The player may be rewarded 450 for the side wager when the rank of the first two of the plurality of cards distributed to the player matches the defined combination of cards.

In one example, determining whether the first two of the plurality of cards distributed to the player match the defined combination of cards further comprises determining whether the first two of the plurality of cards match one of a plurality of defined combinations of cards where the plurality of defined combinations are fewer in number than a total number of possible card combinations. For example, when the card game is played using playing cards, the plurality of defined combinations may include at least the following card combinations:

a Jack of diamonds card and a Queen of spades card;

a King card and a Queen card of a same card suit; and

a King card and a Queen card of different card suits.

The method may include revealing one of the plurality of cards distributed to the dealer and designating a suit of the one of the plurality of cards distributed to the dealer as a trump suit. The King card and the Queen card of the same card suit card, when in the combination identified above, may be present in the following two card combinations and result in a reward that may differ based on which of the two card combinations is present:
the King card and the Queen card of the same card suit, the same card suit of the King card and the Queen card matching the trump suit; and
the King card and the Queen card of the same card suit, the same card suit of the

King card and the Queen card being different from the trump suit.

For example, when the card combination matches the trump suit, the reward may be greater than when the card combination does not match the trump suit. The card combinations may further include a combination of a ‘9’ card in the trump suit combined with any other card. The player may be rewarded for the side wager with one of a plurality of rewards selected based at least in part on which of the card combinations corresponds to the first two of the plurality of cards.

The card game of the method may be Blackjack. The main wager may relate to a total value of the plurality of cards distributed to the player or the dealer. The side wager may relate to specific card combinations defined in part by a suit of the plurality of cards distributed to the player. The method may include rewarding the player for the side wager even when the main wager is lost when the plurality of cards distributed to the player match the defined combination of cards. In another example, the method may include rewarding the player for the side wager when the main wager is won and the plurality of cards distributed to the player match the defined combination of cards. In another example, the method may include withholding a reward to the player for the side wager regardless of whether the main wager is won or lost when the plurality of cards distributed to the player are different than the defined combination of cards.

The player may include multiple players. In other words, multiple players may simultaneously play the game, either in person, or across a network using an electronic device. In some examples, the payout may vary depending on the number of players playing and/or whether other of the participating players earn a reward for the side wager. In some examples, the side wager may be received when the main wager is received or at a different time, such as before or after the main wager. For example, the main wager may be received before the cards are distributed and the side wager may be received at the same time or at a subsequent time before the game has ended. The side wager may be received before distributing the plurality of cards distributed to the player or before the player looks at one or more of the plurality of cards distributed to the player. The player may be permitted to make the side wager at a plurality of different times during the game. The method may include reducing or increasing a reward for the side wager based on when the side wager is made. Where the player is dealt more than two cards, such as at least three cards, the side wager may still be based on the first two cards dealt to the player.

The method may be implemented with involvement of any number of players, as stated above. The method may include revealing the plurality of cards distributed to the dealer for the main wager when a total of the value of the plurality of cards distributed to at least one of a plurality of players is less than or equal to the predetermined value (e.g., 21). For example, the dealer's cards may be revealed when at least one of the players does not bust.

In some examples, this or other methods described herein may be implemented wholly or partially as computer readable program code executed by a processor and the computer readable code may be embodied on a non-transitory computer usable medium.

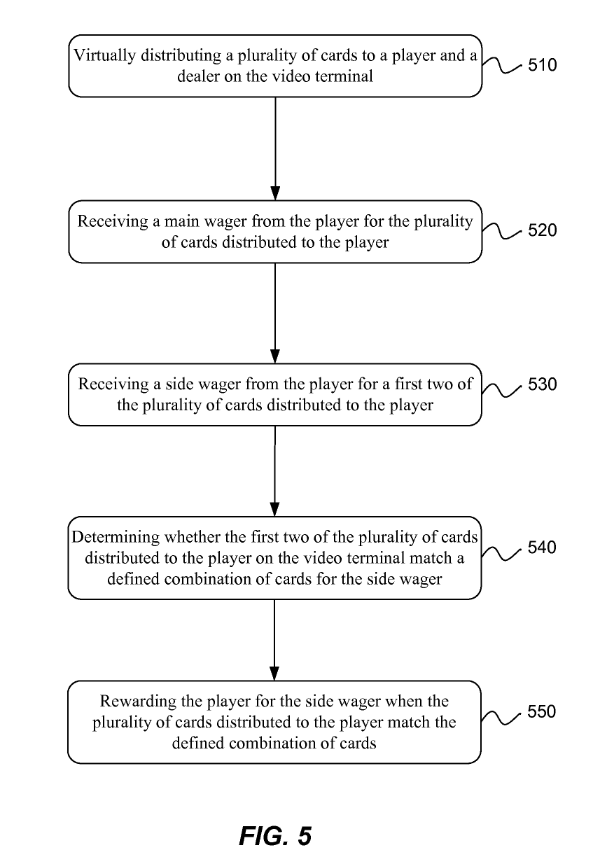

Referring now to FIG. 5, a flow diagram of a method for playing a card game using representations of cards, with rules to define a value of the cards is illustrated in accordance with an example of the present technology. The method may include virtually distributing 510 a plurality of cards to a player and a dealer on the video terminal. A main wager may be received 520 from the player through a physical interface of the video terminal for the plurality of cards distributed to the player. A side wager may be received 530 from the player through the physical interface of the video terminal for a first two of the plurality of cards distributed to the player. The method may include determining 540 whether a rank of the first two of the plurality of cards distributed to the player on the video terminal matches a defined combination of cards for the side wager and rewarding 550 the player for the side wager when the rank of the plurality of cards distributed to the player matches the defined combination of cards. Rewarding the player for the side wager may be independent of rewarding the player for the main wager. The method may also include rewarding the player for the side wager differently depending on a suit of a face up card of the plurality of cards distributed to the dealer.

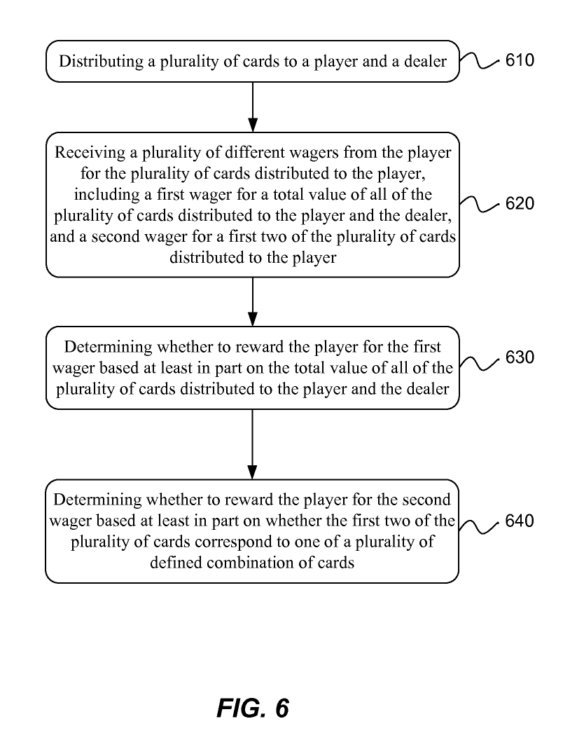

Referring now to FIG. 6, a flow diagram of a computer-implemented method for playing a card game using cards is illustrated in accordance with an example of the present technology. The method may be performed under the control of one or more computer systems configured with executable instructions, and may include, for example, distributing 610 a plurality of cards to a player and a dealer. The method may include receiving 620 a plurality of different wagers from the player for the plurality of cards distributed to the player, including a first wager for a total value of all of the plurality of cards distributed to the player and the dealer, and a second wager for a first two of the plurality of cards distributed to the player. The method may include determining 630 whether to reward the player for the first wager based at least in part on the total value of all of the plurality of cards distributed to the player and the dealer. The method may further include determining 640 whether to reward the player for the second wager based at least in part on whether a rank of the first two of the plurality of cards correspond to one of a plurality of defined combination of cards. It is noted that determining whether to reward the player for the second wager may optionally be independent of determining whether to reward the player for the first wager. Also, the reward for the side wager may vary dependent upon a suit of a face up card of the plurality of cards distributed to the dealer, or the rank of the plurality of cards distributed to the player. The method may further include withholding a reward for the second wager from the player when more than the first two of the plurality of cards are distributed to the player before the player announces a correspondence of the first two of the plurality of cards to the one of the plurality of defined combinations of cards. This announcement may be made verbally, by making a physical gesture, by making a selection via an electronic interface or in any other suitable manner, which may depend at least in part on the medium by which the player is participating in the game.

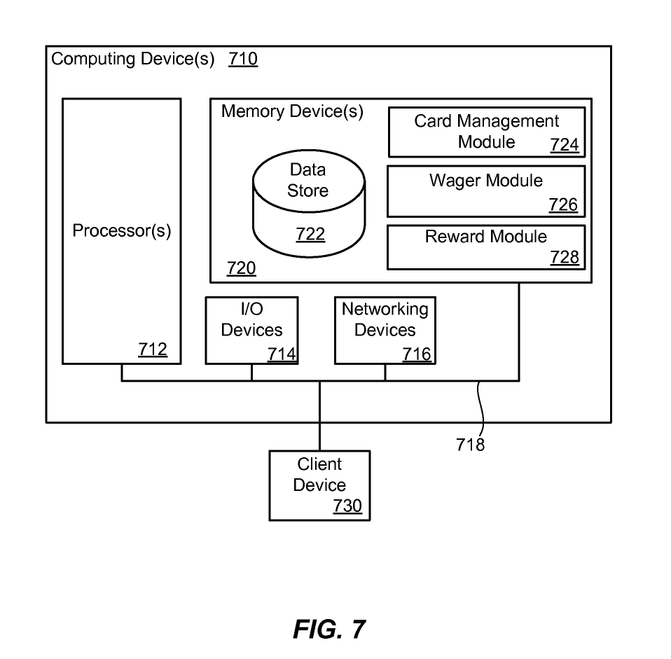

FIG. 7 illustrates a computing device 710 on which modules of this technology may execute. A computing device 710 is illustrated on which a high level example of the technology may be executed. The computing device 710 may include one or more processors 712 that are in communication with memory devices 720. The computing device 710 may include a local communication interface 718 for the components in the computing device. For example, the local communication interface 718 may be a local data bus and/or any related address or control busses as may be desired.

The memory device 720 may contain modules that are executable by the processor(s) and data for the modules. Located in the memory device 720 are modules executable by the processor. For example, a card management module 724, a wager module 726, and a reward module 728, as well as other modules, may be located in the memory device 720. A data store 722 may also be located in the memory device 720 for storing data related to the modules and other applications along with an operating system that is executable by the processor(s) 712.

The computing device 710 may further include or be in communication with a client device 730, which may include a display device. The client device 730 may be available for an administrator to use in interfacing with the computing device 710, such as to review operation of a virtual computing instance, make improvements to machine learning models and so forth.

Various applications may be stored in the memory device 720 and may be executable by the processor(s) 712. Components or modules discussed in this description that may be implemented in the form of software using high programming level languages that are compiled, interpreted or executed using a hybrid of the methods.

The computing device 710 may also have access to I/O (input/output) devices 714 that are usable by the computing devices. An example of an I/O device 714 is a display screen that is available to display output from the computing devices. Other known I/O device may be used with the computing device as desired. Networking devices 716 and similar communication devices may be included in the computing device 710. The networking devices 716 may be wired or wireless networking devices 716 that connect to the internet, a LAN, WAN, or other computing network.

The components or modules that are shown as being stored in the memory device 720 may be executed by the processor 712. The term “executable” may mean a program file that is in a form that may be executed by a processor 712. For example, a program in a higher level language may be compiled into machine code in a format that may be loaded into a random access portion of the memory device 720 and executed by the processor 712, or source code may be loaded by another executable program and interpreted to generate instructions in a random access portion of the memory to be executed by a processor 712. The executable program may be stored in any portion or component of the memory device 720. For example, the memory device 720 may be random access memory (RAM), read only memory (ROM), flash memory, a solid state drive, memory card, a hard drive, optical disk, floppy disk, magnetic tape, or any other memory components.

The processor 712 may represent multiple processors and the memory 720 may represent multiple memory units that operate in parallel to the processing circuits. This may provide parallel processing channels for the processes and data in the system. The local interface may be used as a network to facilitate communication between any of the multiple processors and multiple memories. The local interface may use additional systems designed for coordinating communication such as load balancing, bulk data transfer, and similar systems.

While the flowcharts presented for this technology may imply a specific order of execution, the order of execution may differ from what is illustrated. For example, the order of two more blocks may be rearranged relative to the order shown. Further, two or more blocks shown in succession may be executed in parallel or with partial parallelization. In some configurations, one or more blocks shown in the flow chart may be omitted or skipped. Any number of counters, state variables, warning semaphores, or messages might be added to the logical flow for purposes of enhanced utility, accounting, performance, measurement, troubleshooting or for similar reasons.

Some of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more blocks of computer instructions, which may be organized as an object, procedure, or function. Nevertheless, the executables of an identified module need not be physically located together, but may comprise disparate instructions stored in different locations which comprise the module and achieve the stated purpose for the module when joined logically together.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices. The modules may be passive or active, including agents operable to perform desired functions.

The technology described here may also be stored on a computer readable storage medium that includes volatile and non-volatile, removable and non-removable media implemented with any technology for the storage of information such as computer readable instructions, data structures, program modules, or other data. Computer readable storage media include, but is not limited to, RAM, ROM, EEPROM, flash memory or other memory technology, CD-ROM, digital versatile disks (DVD) or other optical storage, magnetic cassettes, magnetic tapes, magnetic disk storage or other magnetic storage devices, or any other computer storage medium which may be used to store the desired information and described technology. As used herein, the terms “medium” and “media” may be interchangeable with no intended distinction of singular or plural application unless otherwise explicitly stated. Thus, the terms “medium” and “media” may each connote singular and plural application.

The devices described herein may also contain communication connections or networking apparatus and networking connections that allow the devices to communicate with other devices. Communication connections are an example of communication media. Communication media typically embodies computer readable instructions, data structures, program modules and other data in a modulated data signal such as a carrier wave or other transport mechanism and includes any information delivery media. A “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency, infrared, and other wireless media. The term computer readable media as used herein includes communication media.

Reference was made to the examples illustrated in the drawings, and specific language was used herein to describe the same. It will nevertheless be understood that no limitation of the scope of the technology is thereby intended. Alterations and further modifications of the features illustrated herein, and additional applications of the examples as illustrated herein, which would occur to one skilled in the relevant art and having possession of this disclosure, are to be considered within the scope of the description.

Furthermore, the described features, structures, or characteristics may be combined in any suitable manner in one or more examples. In the preceding description, numerous specific details were provided, such as examples of various configurations to provide a thorough understanding of examples of the described technology. One skilled in the relevant art will recognize, however, that the technology may be practiced without one or more of the specific details, or with other methods, components, devices, etc. In other instances, well-known structures or operations are not shown or described in detail to avoid obscuring aspects of the technology.

Although the subject matter has been described in language specific to structural features and/or operations, it is to be understood that the subject matter defined in the appended claims is not necessarily limited to the specific features and operations described above. Rather, the specific features and acts described above are disclosed as example forms of implementing the claims. Numerous modifications and alternative arrangements may be devised without departing from the spirit and scope of the described technology.

1. A computer implemented method for playing a card game using a deck of cards with rules to define a value of the cards in the deck, the method comprising:
distributing a plurality of cards to a player and a dealer;
receiving a main wager from the player for the plurality of cards distributed to the player;
receiving a side wager from the player for a first two of the plurality of cards distributed to the player;
determining whether a rank of the first two of the plurality of cards distributed to the player matches a defined combination of cards for winning the side wager; and
rewarding the player for the side wager when the rank of the first two of the plurality of cards distributed to the player matches the defined combination of cards.

2. The method of claim 1, wherein determining whether the first two of the plurality of cards distributed to the player match the defined combination of cards further comprises determining whether the first two of the plurality of cards match one of a plurality of defined combinations of cards, the plurality of defined combinations being fewer in number than a total number of possible card combinations.

3. The method of claim 2, wherein the card game is played using playing cards and the plurality of defined combinations include at least the following card combinations:
a Jack of diamonds card and a Queen of spades card;
a King card and a Queen card of a same card suit; and
a King card and a Queen card of different card suits.

4. The method of claim 3, further comprising revealing one of the plurality of cards distributed to the dealer and designating a suit of the one of the plurality of cards distributed to the dealer as a trump suit, and wherein the King card and the Queen card of the same card suit card combination includes the following two card combinations:
the King card and the Queen card of the same card suit, the same card suit of the King card and the Queen card matching the trump suit; and
the King card and the Queen card of the same card suit, the same card suit of the King card and the Queen card being different from the trump suit.

5. The method of claim 4, wherein the card combinations further include a combination of a ‘9’ card in the trump suit combined with any other card.

6. The method of claim 3, further comprising rewarding the player for the side wager with one of a plurality of rewards selected based at least in part on which of the card combinations corresponds to the first two of the plurality of cards.

7. The method of claim 1, wherein the card game is Blackjack, the main wager relates to a total value of the plurality of cards distributed to the player or the dealer, and the side wager relates to specific card combinations defined in part by a suit of the plurality of cards distributed to the player, the method further comprising rewarding the player for the side wager when the main wager is lost and the plurality of cards distributed to the player match the defined combination of cards.

8. The method of claim 1, wherein the card game is Blackjack, the main wager relates to a total value of the plurality of cards distributed to the player or the dealer, and the side wager relates to specific card combinations defined in part by a suit of the plurality of cards distributed to the player, the method further comprising rewarding the player for the side wager when the main wager is won and the plurality of cards distributed to the player match the defined combination of cards.

9. The method of claim 1, wherein the card game is Blackjack, the main wager relates to a total value of the plurality of cards distributed to the player or the dealer, and the side wager relates to specific card combinations defined in part by a suit of the plurality of cards distributed to the player, the method further comprising withholding a reward to the player for the side wager regardless of whether the main wager is won or lost when the plurality of cards distributed to the player are different than the defined combination of cards.

10. The method of claim 1, wherein the side wager is received when the main wager is received.

11. The method of claim 1, wherein the side wager is received before distributing the plurality of cards distributed to the player.

12. The method of claim 1, wherein the plurality of cards distributed to the player comprises at least three cards.

13. The method of claim 1, wherein the player comprises a plurality of players.

14. A method for playing a card game using representations of cards on a video terminal using a processor and a memory, with rules to define a value of the cards, comprising:
virtually distributing a plurality of cards to a player and a dealer on the video terminal;
receiving a main wager from the player through a physical interface of the video terminal for the plurality of cards distributed to the player;
receiving a side wager from the player through the physical interface of the video terminal for a first two of the plurality of cards distributed to the player;
determining whether a rank of the first two of the plurality of cards distributed to the player on the video terminal matches a defined combination of cards for the side wager; and
rewarding the player for the side wager when the rank of the plurality of cards distributed to the player matches the defined combination of cards.

15. The method of claim 14, wherein rewarding the player for the side wager is independent of rewarding the player for the main wager.

16. The method of claim 14, wherein the defined combination of cards includes a plurality of combinations of cards fewer in number than a total number of potential card combinations and defined at least in part by a suit of the cards, the method further comprising rewarding the player for the side wager based at least in part on which of the plurality of combinations of cards matches the first two of the plurality of cards.

17. The method of claim 16, further comprising rewarding the player for the side wager differently depending on a suit of a face up card of the plurality of cards distributed to the dealer.

18. A non-transitory computer readable storage medium comprising executable instructions which, when executed, operate as a method for playing a card game using cards, with rules to define a value of the cards, the method comprising:
distributing a plurality of cards to a player and a dealer;
receiving a plurality of different wagers from the player for the plurality of cards distributed to the player, including a first wager for a total value of all of the plurality of cards distributed to the player and the dealer, and a second wager for a first two of the plurality of cards distributed to the player;
determining whether to reward the player for the first wager based at least in part on the total value of all of the plurality of cards distributed to the player and the dealer; and
determining whether to reward the player for the second wager based at least in part on whether a rank of the first two of the plurality of cards correspond to one of a plurality of defined combination of cards;
wherein determining whether to reward the player for the second wager is independent of determining whether to reward the player for the first wager, and wherein the reward for the side wager varies dependent upon a suit of a face up card of the plurality of cards distributed to the dealer.

19. The computer readable storage medium of claim 18, wherein the method further comprises rewarding the player for the first and second wagers based on a result of the determining steps.

20. The computer readable storage medium of claim 18, wherein the method further comprises withholding a reward for the second wager from the player when more than the first two of the plurality of cards are distributed to the player before the player announces a correspondence of the first two of the plurality of cards to the one of the plurality of defined combinations of cards.
